(19) United States
(12) Patent Application Publication
(10) Pub. No.: US 2015/0379480 A1
(43) Pub. Date: Dec. 31, 2015

(54) Method and System for Repair and / or Maintenance of Bicycles

(71) Applicant: Matthias Taplan, Muenchen (DE)

(72) Inventor: Matthias Taplan, Muenchen (DE)

(21) Appl. No.: 14/731,446

(22) Filed: Jun. 5, 2015

(30) Foreign Application Priority Data
Jun. 5, 2014 (DE) 10 2014 210 780.6

(51) Int. Cl. G06Q 10/00; G06Q 10/06

(52) U.S. Cl. CPC G06Q 10/20; G06Q 10/06311

(57) ABSTRACT

The present invention relates to a method for maintaining and/or repairing at least one bicycle (110) of a plurality of bicycles (110) distributed in the field comprising first identification data, wherein the method comprises the following steps:
a. Receiving (140) a maintenance and/or repair request via a network, wherein the request comprises first identification data of the bicycle (110);
b. Sending (150) a maintenance and/or repair request to a mobile maintenance and repair unit (130) with a specification of a location where the bicycle (110) is available for maintenance and/or repair;
c. Receiving a confirmation that the mobile maintenance and repair unit (130) has arrived at the location.

### 1. FIELD OF TECHNOLOGY

The present invention relates to a method and system for repair and/or maintenance of bicycles distributed in the field via mobile repair and maintenance units.

### 2. TECHNICAL BACKGROUND

Bicycles have always been an integral component of the urban individual transport and are used for both private and commercial purposes. Bicycle couriers carry goods and packages whereas office workers use bicycles for their journey to the company or to a client. A reliable functioning as well as a fast repair in case of a damage are of great importance.

Bicycles are going to be more and more technically complex due to high expectations of the users. By use of technologically advanced components, such as hydraulic disc brakes, suspension forks, complex gear changes etc. the number of the required spare parts rises enormously. In addition, the repair and change of these technologically advanced components is going to be more and more difficult and can mostly be executed only by skilled persons. But even for skilled persons the choice of suitable spare parts presents a challenge because of the high number of different manufacturers and the even greater number of spare parts resulting from it. For example, pinions for gear changes of different manufacturers are nearly indistinguishable. The same is for brake linings or discs for disc brakes. Therefore, it is not unusual that a spare part is used for a usual maintenance and/or repair order that does not fit or is not intended. But wrong parts for replacement can cause significant damage. If, for instance, unsuitable spare parts are used for a brake, this can lead to severe traffic accidents because through the use of a wrong spare part of a brake its brake force could be reduced considerably.

Professional workshops doing the repair of a damaged bicycle are often only seasonal businesses which are closed in winter. Furthermore, opening hours are hard to arrange with the daily working life, especially for the above-mentioned office workers. This leads among other things to a situation whereby maintenance dates cannot be kept and cyclists often use bicycles that are badly or not maintained in public traffic.

The present invention relies on the problem to provide an improved solution for the maintenance and/or repair of bicycles.

### 3. SUMMARY OF THE INVENTION

This problem is solved by the independent claims of the present application. In an embodiment, the present invention relates to a method for maintaining and/or repairing at least one bicycle of a plurality of bicycles distributed in the field via first identification data, wherein the method comprises the following steps:
a. Receiving a maintenance and/or repair request via a network, wherein the request comprises first identification data of the bicycle;
b. Sending of a maintenance and/or repair request to a mobile repair and maintenance unit with a specification of a location where the bicycle is available for maintenance and/or repair.
c. Receiving a confirmation that the mobile repair and

The referenced method for maintaining and/or repairing is able to receive maintenance and/or repair requests of a user for bicycles and to transmit them to one or more mobile maintenance and repair units via maintenance and/or repair orders. The maintenance and/or repair orders can be transmitted by the user by using, for example, an internet site. By means of first identification data, e.g. the frame number of the bicycle, the order is associated with an individual bicycle. For example, the identification data are entered in a text box of the abovementioned internet site and transmitted by the user. The method of creating a maintenance and/or repair order will be simplified in the sense that the user can also transmit the current location of the bicycle to be maintained. The advantage of the method lies in the possibility that a user can order the maintenance and repair unit to any place where, for example, a damage has been occurred. Thereby, the user does not have to transport his damaged bicycle. Thus, the use of a maintenance and/or repair method for bicycles is significantly simplified and the efficiency and mobility of bicycles rises.

Via transmission of a confirmation, e.g. an email etc., the mobile repair and maintenance unit can signalize its arrival at the desired location.

Thus, the method controls if and when a mobile maintenance and repair unit arrives at the desired location. This method particularly simplifies the disposition of many different maintenance and/or repair orders when using many mobile maintenance and repair units.

Preferably, sending the maintenance and/or repair order in step b. does not enable an identification of the bicycle.

This guarantees that a maintenance and repair unit must do an additional identification on side of the bicycle to be maintained and/or to be repaired. This beneficial feature leads to an additional control mechanism to ensure that only the correct bicycle is maintained and/or repaired. The danger of confusion that the wrong bicycle is maintained and/or repaired is reduced markedly.

In a further exemplary embodiment of the present invention, the method comprises receiving the confirmation that comprises receiving second identification data of the bicycle. Preferably, the second identification data have been created by a reader by means of machine-reading an identification element on the bicycle.

The second identification data, e.g. a QR-code printed on the bicycle, now allow a system-supported and therefore error-reduced second identification of the bicycle to be maintained and/or repaired. These second identification data can be read sensor-based with a QR-code scanner, a bar code scanner or a simple camera. As mentioned above, a control mechanism is created which ensures a clear allocation of the bicycle to be maintained and/or repaired to the respective order. The danger of confusion and the related use of wrong spare parts is reduced significantly and the mobility of the bicycle is increased. Furthermore, the traffic safety of the bicycle rises because the use of wrong spare parts is prevented.

Preferably, the method further comprises the step of providing a list of parts of the identified bicycle in reply to receiving the second identification. In another embodiment, the method further comprises the step of receiving a message, the message including at least one bicycle part used during the maintenance and/or repair.

When the bicycle is identified through reading the second identification data by a mobile maintenance and repair unit, a list of parts is being created for the mobile maintenance and repair unit. It is also possible that the list of parts contains all parts of the bicycle. Only providing a list of spare parts after transmission of the second identification data ensures that it is the desired list of parts. In this way, it prevents the confusion of lists of parts. The list of parts can be transmitted to the mobile maintenance and repair unit on an earlier occasion. But preferably it is only visible after the second identification. Due to the reason that the list of parts can include all parts of a bicycle, this simplifies a restoration of the original condition of the bicycle. If additional parts were used (e.g. after a repair in foreign countries during holidays) original parts can be found fast in the list of parts and can be used for the exchange of parts that are not original.

If the mobile maintenance and repair unit uses one or more parts during maintenance and/or repair, also called spare parts, it communicates it, e.g. by email or the like. This arrangement has the advantage that the current parts inventory of a mobile maintenance and repair unit is known. Thereby, suitable follow-up orders for the mobile maintenance and repair units can be selected efficiently from a variety of orders. Only if there are sufficient spare parts left for another repair order, the mobile maintenance and repair unit is able to take it over.

Another advantage of the transmission of the used parts is that it is known which parts are used for a bicycle. If parts have a known limited durability, it is possible to generate maintenance and/or repair orders automatically. Thus the bicycle is always well maintained which leads to an increase of traffic safety. This is ensured, among other things, by storing all bicycles respectively their first and/or second identification data, e.g. in a database.

In a further embodiment, the message comprises a part identification number of at least one bicycle part used during maintenance and/or repair.

By linking a bicycle part with a part identification number ensures that all administered parts can be identified unambiguously. Confusions are not possible and it is not possible to use wrong parts. This leads to an improvement of traffic safety of the bicycles, too.

Preferably, the method according to the present invention further comprises the step of selecting a bicycle part for the at least one bicycle part used for maintenance and/or repair, included in the message.

To fill up fast the inventory of parts of at least one mobile maintenance and/or repair unit after the removal of parts to do maintenance and/or repair work, when receiving the message about the use of a spare part the same part will be selected when receiving a message about the use of a part and thus enables a direct loading with the part when the mobile repair and maintenance unit arrives at the central parts warehouse. Through this it allows that the mobile repair and maintenance unit only has to remain a short time in or at the parts warehouse. As a result, the number of maintenance and/or repair orders (e.g. per day) raises, which leads to a higher number of correct maintained and/or repaired bicycles in traffic.

Preferably, step b of the method according to the invention comprises selecting a mobile maintenance and repair unit of a plurality of mobile maintenance and repair units by means of at least one predetermined criterion. Preferably, the at least one criterion comprises one or more of the following criteria:
i. Locations of the plurality of mobile maintenance and/or repair units;
ii. Inventories of the available parts in the plurality of mobile maintenance and repair units;
iii. A time specification included in the maintenance and/or repair request when the maintenance and/or repair is to be carried out.

In a further embodiment, criterion ii further considers a type and/or the bicycle identified by means of the first identification. In a further preferred embodiment, criterion ii comprises the highest priority when selecting the mobile maintenance and repair unit, followed by criterion iii, followed by criterion i.

By including of the above-mentioned criteria, the embodiment of the method is able to choose by priority a suitable maintenance and repair unit for a maintenance and/or repair order. A maintenance and repair order is assigned to the mobile maintenance and repair unit under the condition that the spare parts that are needed are present in the mobile maintenance and repair unit. When they are not present, the method normally chooses another mobile maintenance and repair unit which has the suitable spare parts. If different maintenance and repair units are possible for carrying out a maintenance and/or repair order according to this criterion, the method also considers the current location of the mobile maintenance and repair units. The order will be preferably assigned to the maintenance and repair unit which is closer to the bicycle to be maintained and/or repaired. Another weighting of the priorities is also possible. It is possible, for example, to consider more the desires of customers regarding location and date of a maintenance and/or repair.

Furthermore the method considers the date when the maintenance and/or repair is desired by the customer. If it is not possible for a near maintenance and repair unit to do the maintenance and/or repair at the desired time because it has to do one or more maintenance and/or repair orders before, another maintenance and/or repair unit can be assigned by the method.

In a further embodiment, the method further comprises the step of receiving a confirmation of the maintenance and/or repair order from the mobile maintenance and repair unit. Preferably, the steps of receiving and sending comprise the usage of a mobile radio network and/or the Internet.

When a mobile maintenance and repair unit is assigned by the above-mentioned method for a maintenance and/or repair order, this order will be transmitted to it preferably via a mobile radio network and/or via Internet or via something similar. The transmission preferably takes place electronically. There are also other transmission methods, e.g. via phone. If the mobile maintenance and repair unit accept the transmitted maintenance and/or repair order, it sends a conformation in the form of a message and the reception of the message is made possible by the method. As a consequence, it is always known if and which mobile maintenance and repair unit carries out an order. This is beneficial because it allows the method to use this information for the above-mentioned selection procedure.

In another embodiment, the invention relates to a maintenance and/or repair system for at least on bicycle of a plurality of bicycles distributed in the field having first identification data, wherein the maintenance and/or repair system comprises the following means:
a. Receiving means, configured for receiving of a maintenance and/or repair request over a network, wherein the request comprises the first identification data of the bicycle;
b. Sending means, configured for sending a maintenance and/or repair request to a mobile maintenance and repair unit including a location where the bicycle is located for maintenance and/or repair.
c. Receiving means, configured for receiving a confirmation that the mobile maintenance and repair unit has arrived at the location.

Preferably, the maintenance and/or repair system is able to carry out one of the methods as described above.

Furthermore, the present invention relates to a method for operating a mobile maintenance and repair unit for at least one bicycle of plurality of bicycles distributed in the field, wherein the method comprises the following steps:
a. Receiving a maintenance and/or repair request from a maintenance and/or repair system as described above;
b. Machine-reading of an identification element at a bicycle by means of a reader for receiving second identification data of the bicycle; and
c. Sending the second identification data of the bicycle to the maintenance and/or repair system as described above.

When a user transmits a maintenance and/or repair order, the order is forwarded to a maintenance and repair unit. The method to run a mobile maintenance and repair unit allows to receive the order preferably via a network, e.g. via a mobile radio network. Thereby the mobile maintenance and repair unit can stay at different places and nevertheless is able to receive fast and reliable maintenance and/or repair orders. Thus, a return to a specific location is not necessary to receive new orders. It is also beneficial that bicycles to be maintained and/or to be repaired can be found, repaired and/or maintained fast and without delay. Hereby the mobility of the mentioned bicycles raises significantly and are fast and reliable ready for professional or private trips of the user. The bicycles to be maintained by maintenance and repair units preferably have identification data, e.g. a QR-code or something similar. The method to run a mobile maintenance and repair unit allows the use of a scanner which can read the code via a sensor. Thus the code serves as mentioned second identification data. These second identification data can be transmitted to the maintenance and/or repair system after reading.

Preferably, the received maintenance and/or repair request of step a does not allow an identification of the bicycle.

Preferably, only in connection with the reading and transmitting of the second identification data an identification of the bicycle to be maintained and/or repaired is possible. Therefore, a confusion of the bicycle to be maintained and/or repaired with another bicycle is eliminated. It is beneficial that via avoidance of a confusion, the installation or exchange of inappropriate or unwanted parts is avoided.

Thus, a significant reduction of wrong installations is achieved which leads to a perfect running of the bicycles to be maintained and/or repaired. Once again the traffic safety of the bicycles raises and the potential risk of accidents caused by the use of wrong or unsuitable parts is reduced.

In another preferred embodiment of the present invention, the method further comprises the step of receiving a list of parts of the identified bicycle in reply to sending or machine-reading of the second identification. Preferably, the list of parts comprises a part identification number. Preferably, the method further comprises the step of sending a message, the message including at least one bicycle part used during the maintenance and/or repair. Preferably, the message comprises a part identification number of at least one bicycle part used during maintenance and/or repair.

Because only after transmitting the second identification data, the list of spare parts of the bicycle to be maintained and/or repaired can be received or accessed by the mobile maintenance and repair unit, there is another control mechanism which makes sure that the list of spare parts belonging to the maintenance and/or repair order is being transmitted or is visible. Here it is important that the list of spare parts could be transmitted in advance to the mobile maintenance and repair unit but is only visible after transmission of the second identification data. As a result, the single spare parts are identified unambiguously by a spare part identification number. The danger of confusion of both bicycles to be maintained and/or to be repaired and spare parts is reduced significantly. This ensures that always the right spare parts are used.

It is also advantageous to transmit one or more spare parts being used for maintenance and/or repair to the maintenance and/or repair system mentioned above. This system preferably knows always the current inventory of the mobile maintenance and repair unit and can use this information for the disposition of further maintenance and/or repair orders. Through the use of spare part identification numbers, all spare parts are distinguishable, even when they look similar which has positive effects on the choice of suitable spare parts.

Another preferable embodiment of the present invention comprises the step of sending a confirmation of the maintenance and/or repair order to the maintenance and/or repair system. Preferably, the steps of receiving and sending comprise the usage of a mobile radio network.

The method to run a mobile maintenance and repair unit is able to inform the maintenance and/or repair system that a mobile maintenance and repair unit accepts a maintenance and/or repair order. Through this information the maintenance and repair system always knows about the degree of utilization of all maintenance and repair units and is able to optimize the order disposition and make it more efficient. Through the use of a mobile radio network, the message can be transmitted to the maintenance and/or repair system without being bound to a location. Thus, the information reaches the mentioned system always fast and this additionally optimizes the order disposition.

Preferably, at least one bicycle part, used by the mobile maintenance and repair unit, is identified by means of machine-reading the identification data.

Preferably, the read part identification number is compared to part identification numbers in the list of parts. Preferably, a message is issued if it is determined that the machine-read part identification number does not match any part identification number stored in the list of parts.

The mechanical reading of a spare part identification number, which is realized for example via a QR-code or a barcode, allows an automatic write-off of the spare part from the inventory of spare parts of the mobile maintenance and repair unit. Furthermore the machine-reading and the comparison between the read spare part identification numbers allow the implementation of a further control mechanism. When a wrong or improper spare part is taken from the inventory of spare parts of a mobile maintenance and repair unit for maintenance and/or repair of a bicycle, there will be a message, e.g. in form of an acoustical or visual signal. The signal prevents the use of a wrong or improper spare part. This leads to a significant reduction of the error rate regarding the use of wrong or improper spare parts which leads to a higher traffic safety of the bicycles to be maintained and/or to be repaired.

Preferably, the present invention also relates to a mobile maintenance and repair system for maintaining and/or repairing of at least one bicycle of a plurality of bicycles distributed in the field, comprising the following means:
a. Receiving means, configured for receiving a maintenance and/or repair request from a maintenance and/or repair system as mentioned above;
b. Reader, configured for reading an identification element at the bicycle for receiving second identification data of the bicycle; and
c. Sending means, configured for sending the second identification data of the bicycle to the maintenance and/or repair system as mentioned above.

Preferably, the mobile maintenance and repair unit is further configured to perform a method as described above.

Furthermore, an embodiment of the present invention relates to a bicycle for being used in connection with a maintenance and/or repair system as described above, comprising second identification data, machine-readable by a reader. Preferably, the second identification data are provided at or in the bicycle in form of one or more of the present codes:
i. a code in an RFID chip;
ii. a bar code;
iii. A QR-code.

For example, a QR-code or a barcode is fixed at the frame of the bicycle or a RFID chip or something similar is fixed in the frame of the bicycle which allows to read the second identification data. Another advantage of a code which is fixed on or in the frame is that further bicycles that want to join the system described in this application can be integrated through fixing the codes as mentioned above. A machine-reading of the code is much less error-prone than a manual reading. Through this, the correct allocation of a maintenance and/or repair order to the desired bicycle is guaranteed.

In another preferred embodiment, the bicycle further comprises first identification data, arranged at the bicycle, being readable without a reader.

The use of first identification data which are human readable has two more advantages. On the one hand the first identification data can be used by a user for sending a maintenance and/or repair order to the maintenance and/or repair system. Through inserting the data it is simple to create an order. As these first identification data are fixed at the bicycle, they cannot be forgotten by the user at home or at the office. Thus, the user is always able to send an order. On the other hand another advantage is that the mobile maintenance and repair unit is able to identify the bicycle to be maintained or to be repaired even if the second identification data are not readable because of impurity or loss. For example the identification can be made through comparison of the first identification data with the data deposited in the maintenance and/or repair system over the phone.

Another preferred embodiment of the present invention relates to a computer program comprising instructions for performing the methods as described above.

Finally, this invention relates to a distributed bicycle maintenance system, comprising a maintenance and/or repair system as described above and at least one mobile repair and maintenance unit as described above for repairing at least one bicycle as described above.

### 4. DESCRIPTION OF THE FIGURES

Below, preferred embodiments of the present invention are explained with reference to the accompanying figures:

FIG. 1: schematic view of a maintenance and/or repair system, of a mobile maintenance and repair unit and of a bicycle according to an embodiment of the invention;

FIG. 2: schematic view of an identification element according to an embodiment of the invention;

FIG. 3: schematic view of the creation of a repair and/or maintenance order in embodiment of the invention; and

FIG. 4: schematic view of the execution of a repair and/or maintenance order according to an embodiment of the invention.

### 5. DESCRIPTION OF PREFERRED EMBODIMENTS

Aspects of the present invention are described below in context with a preferred embodiment.

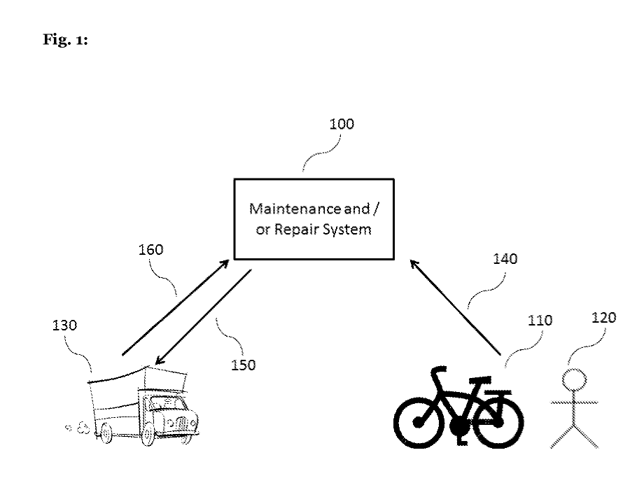

FIG. 1 shows a maintenance and/or repair system 100, which is established for receiving 140 a maintenance and/or repair order from a user 120 for a bicycle 110. Below, the term bicycle is to be understood as all human-powered means of transport also with electric support-engine.

However, there is also the possibility to use this invention for other forms of transport as for example Segways.

The reception 140 of a maintenance and/or repair order can be realized with an internet site which preferably is based on a database. Other forms of transmission of the order are also possible. Possible is, for example, a phone call or a fax, an email or something similar. Preferably, the user 120 uses for transmission a smartphone app which is especially designed for this system. Particularly, the simple use of the system for the user 120 is in the foreground.

The user 120 of a bicycle 110 is going to send the mentioned maintenance and/or repair order when the bicycle 110 should be maintained and/or repaired. A maintenance can be the exchange of a worn tire or the oiling of the chain. A repair, in contrast, normally focuses on the removal of a malfunction. This could be the exchange of a defect pinion of the gear shift or the assembly of a lost part. But it is also possible to install new parts which previously were not installed at the bicycle 110.

The maintenance and/or repair system 100 is such that it is able to receive a lot of maintenance and/or repair orders by a multitude of users 120. Furthermore, the system 100 has access to a plurality of maintenance and repair units 130.

A maintenance and repair unit 130 is, e.g., a delivery van or something similar which includes a parts warehouse with spare parts and other bicycle parts. Additionally, the mobile maintenance and repair unit 130 has a GPS module (or similar modules) and sends its position to the maintenance and/or repair system 100 from time to time, e.g. via using a mobile connection or something similar. Furthermore the mobile maintenance and repair unit 130 has a scanner which allows to scan the spare parts being used from the integrated parts warehouse. Thus, the spare part gets written off of the local inventory of the mobile maintenance and repair unit 130. The parts inventory of a unit 130 is always communicated to the maintenance and/or repair system 100. This also preferably works with a mobile connection. The same scanner can be used for registration of spare parts when they are loaded into a mobile maintenance and repair unit 130. Additionally, the mobile maintenance and repair unit 130 can have a mobile card payment system such that users can pay for conducted maintenances, repairs and used spare parts directly via EC card or credit card. Other mobile payment systems are also possible. A mobile maintenance and repair unit 130 can also have a printer to print receipts and/or delivery notes. It is also possible to use a machine with a touch sensitive area allowing for signing of a delivery note or something similar.

In an embodiment the maintenance and repair unit 130 can also carry whole bicycles. If a maintenance and/or repair ordered by a user 120 cannot be done, it allows providing a substitute bicycle. The reason for a maintenance and/or repair which cannot be done is a total loss, for example. Additionally, a maintenance and repair unit 130 has an integrated workshop. It has all needed tools to make the maintenance and/or repair works, e.g., at the roadside or at a parking lot without being bound to a specific location. Normally, a maintenance and repair unit 130 is run by a mechanic. So the mobile maintenance and repair unit 130 is able to carry out proper the maintenance and/or repair.

When a user 120 has send an order to maintain and/or repair a bicycle no to the system 100, this information will be saved in the maintenance and/or repair system 100 to create a maintenance and/or repair order. After that a transmission 150 of the mentioned order to a plurality of maintenance and repair units 130 take place. Preferably, the order contains the location where the maintenance and/or repair should take place. Furthermore, descriptions of deficiencies by the user 120 or the desired maintenance work can be noted in the order. Also the time of day when the maintenance and/or repair should be done can be deposited in the order. If the maintenance and/or repair unit 130 wants to accept the order, it initiates a transmission 160 of a corresponding confirmation to the maintenance and/or repair system 100. Thus, the system 100 knows if the order is carried out by unit 130 or not.

It is possible to run this invention with a franchise system. Thereby, an operator of the inventive maintenance and/or repair system 100 assigns mobile maintenance and/or repair systems 130 to bicycle mechanics. The mechanics run the units 130 on their own. The operator or a third party additionally runs a central parts warehouse, where the mobile maintenance and repair units 130 can be loaded with spare parts for bicycles no.

The advantage is that a bicycle mechanic is relieved of the burden of all commercial activities, e.g. accounting, billing and making written reminders, calculation, procurement etc. The mechanic can concentrate on his work as a mechanic.

It is also possible to have different forms of the mentioned franchise model. For example, there can be placed an obligation on the mechanic as a self-employed operator of the mobile maintenance and repair unit 130 to buy spare parts from the operator who runs the system. Thus, the mechanic is obligated to buy spare parts only from the operator of the maintenance and/or repair system 100 or from a third person who is specified in advance.

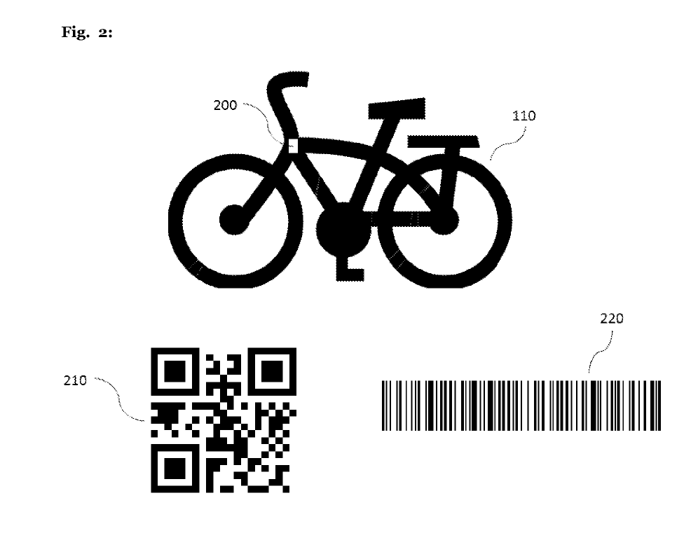

FIG. 2 shows a bicycle 110 which shows on one part 200 a code 210, 220. Code 210, 220 can be a QR-code 210, an RFID chip or a barcode 220. It is also possible to use all other forms of codes. Here it is important that code 210, 220 is readable with a reader. QR-codes 210 are very suitable because they are reliably readable even when they are slightly dirty.

Normally, the reading is sensor-based. The position 200 can be any point on the frame or on another part of the bicycle 110. The code 210, 220 can be glued on the frame. It is also possible to stamp in the codes 210, 220 into the frame.

Furthermore, the bicycle 110 has a frame number which is also stamped into the frame of the bicycle 110. Preferably, it is stamped in that it cannot be removed.

Both the code 210, 220 and the frame number allow to identify the bicycle 110. On the one hand it is used to identify a bicycle 110 to be maintained and/or to be repaired. On the other hand it is easier to identify a stolen bicycle 110.

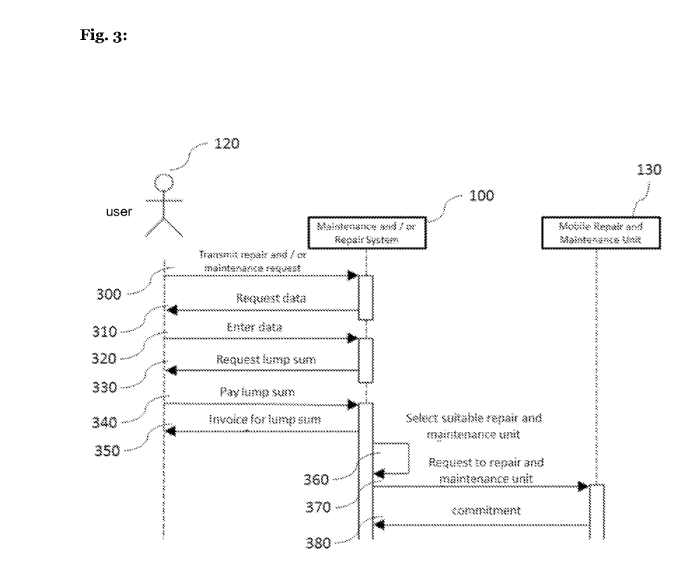

FIG. 3 shows how a user 120 sends a maintenance and/or repair order to the maintenance and/or repair system 100. Additionally, it is shown how the maintenance and/or repair system 100 sends an order to a mobile maintenance and repair unit 130 to carry out the maintenance and/or repair order and the mentioned unit 130 accepts the order.

The transmission of a maintenance and/or repair order 300 by a user 120 for a bicycle 110 to the maintenance and/or repair system 100 takes place as follows:

The user 120 opens an internet site where he can find a price overview for maintenance and/or repair orders. After the price overview there is a log in. The frame number on the bicycle 110 can be used by the user 120 as log in data. A password is not necessary, but possible. Thus, the step of logging in is very simple. By logging in, the maintenance and/or repair order is already linked to the frame number of the bicycle 110. The effort for a user 120 is reduced significantly by this simple way of ordering. For example he does not has to remember another password etc. By using an online system, the user 120 does not have to wait in a telephone queue which leads to a higher comfort of the whole system.

The user 120 now is asked by the maintenance and/or repair system 100 to enter different data 310. Then the user 120 enters the data 320. Now the user 120 specifies the address or a location where the maintenance and/or repair of the bicycle 110 should take place. Normally, the address is his residential or business address or another location where the damage took place to the bicycle 110. Optionally, the user 120 can specify a different billing address. Furthermore, the user 120 inserts an email address to get a confirmation of the reception of the order and to deliver an electronic invoice for a due travelling expense and the following maintenance and/or repair.

Furthermore, the user 120 inserts a preferred date and an optional preferred time for the maintenance and/or repair and an optional mobile number that the mobile maintenance and repair unit 130 can establish contact when the address is difficult to access (e.g., the doorbell panel is not readable). It is also possible to contact the user 120 by an employee of the operator of the maintenance and/or repair system 100 to arrange another date for maintenance and/or repair of the bicycle 110.

Furthermore, the user 120 can communicate if it is a claim under warranty from his point of view (requirements: original purchaser, two-year period, initial deficiency). The description of the necessary maintenance and/or repair work (e.g., gear shift defect) is also optional. This is optional because the user 120 does not always have the knowledge to describe the damage correctly.

The maintenance and/or repair system 100 also allows an automatic determination if the maintenance and/or repair is a claim under warranty. Preferably, as all bicycles no respectively the identification data and the purchase date are saved in a data base of the system, it is possible to determine if, e.g., certain parts still have a valid warranty of the seller, who is the system operator or another third person.

Also the user 120 marks the box “terms and conditions” with a cross and thereby confirms the terms and conditions. These include, for example, the exclusion of the repair when the bicycle cannot be repaired despite of payment of the journey etc. It is immaterial for the transmission of the maintenance and/or repair order if the user 120 is the purchaser or the owner. After completion of this step 320, the user 120 is being requested to pay a lump sum 330. The lump sum is a deposit and can be paid with an online payment function 340. In the mentioned embodiment it is a requirement that the payment of the lump sum for the journey of the mobile maintenance and repair unit 130 has been paid. When the payment was successful, the user 120 receives a confirmation mail automatically with an invoice for the lump sum 350 and the maintenance and/or repair order will be changed automatically by the maintenance and/or repair system 100 into a maintenance and/or repair order.

Only then the maintenance and/or repair system 100 chooses a suitable maintenance and repair unit 130. The selection 360 preferably will be focused on different priorities. The highest priority has the consideration if a mobile maintenance and repair unit 130 has all necessary spare parts in its integrated inventory which are needed for maintenance and/or repair. This is possible because the maintenance and/or repair system 100 has saved all parts of a bicycle 110 or a bicycle type. The relevant spare parts can be identified by the frame number of the bicycle 110 to be maintained and/or repaired which has been sent during the request. If several mobile maintenance and repair units 130 have a suitable inventory, it is further considered at which location a mobile maintenance and repair unit 130 is currently located.

The mobile maintenance and repair unit 130 next to the maintenance and/or repair location desired by the user 120 is prioritized. If still different mobile maintenance and repair units 130 come into question because the distance to the desired location is the same, the system additionally considers the time of day the user 120 desires when the maintenance and/or repair should be done. When a mobile maintenance and repair unit 130 does a maintenance and/or repair and cannot comply the desired time of day, despite its proximity to the desired location, the maintenance and/or repair order is assigned to another mobile maintenance and/or repair unit 130. In the foreground of the prioritization is to satisfy the user 120. Because of that a different weighting of the prioritization or the use of new user-oriented criteria is possible. It is also possible that the maintenance and/or repair units 130 coordinate maintenance and/or repair dates with the users 120. This can be advantageous when all mobile maintenance and repair units 130 refused to accept a maintenance and/or repair order, for example.

Besides the priority-based determination of a suitable mobile maintenance and repair unit 130 the maintenance and/or repair system 100 is able to create route profiles under consideration of the mentioned priorities. The route profiles make it possible that a multitude of maintenance and/or repair orders can be transmitted to mobile maintenance and repair units 130 so that they are busy and nevertheless can consider the desires of the users 120 regarding location and time of day.

It is also possible to consider probabilities to specify route profiles, e.g. maintenance and/or repair orders at a specific time (e.g. in rush-hour traffic) or at specific locations (e.g. at main roads). These probabilities can be calculated by analyzing data of past time periods and by updating them constantly. It is possible to use so-called data-mining methods, for example. The consideration of probabilities allows the maintenance and/or repair system 100 to locate mobile maintenance and repair units 130 at specific times and at specific locations even before receiving a maintenance and/or repair order. Thus, bicycles no can be maintained and/or repaired as fast as possible.

In case of congestion, this means there are so many maintenance and/or repair orders that they cannot be carried out by the mobile maintenance and repair units 130, an employee of the operator of the system 100 or an automatic software agent can contact the users 120 and make another appointment for the maintenance and/or repair. After choosing a maintenance and repair unit 130 which is suitable for the maintenance and/or repair order, the unit receives a request 370. This request for making a maintenance and/or repair order can be refused or accepted 380 by the mobile maintenance and repair unit 130. When the request is being refused or not accepted, the maintenance and/or repair system 100 assigns the request to another unit 130.

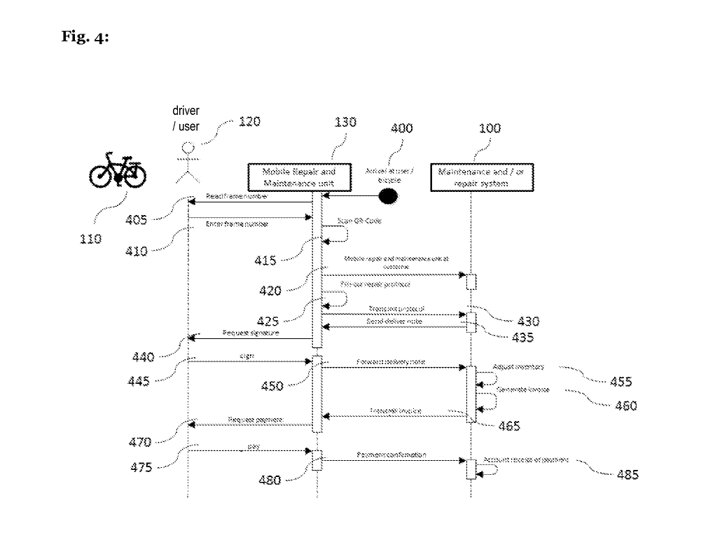

FIG. 4 provides examples of the process of a maintenance and/or repair order by a mobile maintenance and repair unit 130.

After arrival of the mobile maintenance and repair unit 130 at the desired location the mechanic reads 405 the frame number of the bicycle 110 to be maintained and/or repaired. Thus, the respective maintenance and/or repair order can be identified. This step is optional. The frame number is being inserted 410, for example, in a program on a laptop, tablet PC or something similar. It is also possible to run the program on a smartphone. After that, a code on the bicycle 110, e.g. a QR-code, is scanned 415. Only now after scanning of the code the mobile maintenance and repair unit 130 receives the list of spare parts of the bicycle 110. It is also possible that the list of spare parts has been transmitted to the laptop or to the tablet PC in advance. This list would only be visible after scanning the QR-codes 210.

This creates another control mechanism that makes sure that the correct bicycle 110 was chosen for maintenance and/or repair. Furthermore, this makes sure that the mobile maintenance and repair unit 130 is on-site. Additionally this information is sent 420 directly to the maintenance and/or repair system 100. During the maintenance and/or repair, the mechanic fills in a repair protocol 425. The protocol preferably is inserted directly into the laptop or the tablet PC or something similar. This allows a direct transmission 430 of the protocols to the maintenance and/or repair system 100, which can respond with the transmission of a delivery note 435.

As the spare parts are scanned when they are removed from the warehouse of a mobile maintenance and repair unit 130, another consequence is that this automatically will be written into the repair protocol. A mechanic does not have to care about the documentation of the spare parts he used. Furthermore, it prevents that wrong spare parts are written on the later invoice because wrong spare parts for the bicycle 110 are not accepted by the maintenance and/or repair system 100. It is very simple to fill in the protocol with the help of a laptop, a smartphone or a tablet PC. The ergonomics of input are much better by the use of highlighting of used spare parts or spare parts to be used, e.g. fat or italic type.

When a spare part was scanned when removed from the inventory of mobile maintenance and/or repair unit 130, it is noticed and highlighted automatically in the repair protocol. By clicking on the highlighted parts the mechanic can confirm the use of the spare parts. The highlighting prevents also mixing-up or selecting wrong spare parts. Furthermore, the method allows a step-by-step filling-in of the protocol: a mechanic scans a spare part which is immediately highlighted in the repair protocol. Now the mechanic can use the spare part and confirm it by clicking the spare part in the repair protocol after the repair. Now he can take and scan another spare part from the inventory of the mobile maintenance and/or repair unit 130. Now this spare part is highlighted in the protocol and is confirmed by clicking this spare part in the protocol etc.

This automation particularly simplifies the following creation of a delivery note because it is deduced directly from the protocol. Furthermore, the produced maintenance activities (e.g. the cleaning of the chain etc.) are abstractly noted in the protocol, e.g. in form of time units. The concrete needed time is not noted. This simplifies the documentation of a performed order for the mechanic and prevents mistakes while filling-in the protocol. Furthermore, the maintenance and/or repair system 100 notes how many time units are needed for repair and/or removal of a specific spare part. Therefore, the time units can be integrated automatically in the delivery note and/or in the invoice.

The above mentioned registration of warranty claims also allows that spare parts used for a warranty claim are not part of the invoice automatically.

The program on the laptop or tablet PC or something similar right after the reception of the delivery note requires 440 the signature of the user 120. Then the delivery note gets a signature 445 from the user 120. Now the signed delivery note is forwarded 450 to the maintenance and/or repair system 100 and includes information about all used spare parts for maintenance and/or repair and the maintenance activities in form of time units, for example. In reply to reception of the signed delivery note the mobile maintenance and/or repair system 100 updates the saved inventory of spare parts to the mobile maintenance and repair unit 130 in step 455 and instantly generates an invoice 460. The invoice is transmitted 465 to the mobile maintenance and repair unit 130.

The corresponding mechanic now can demand 470 the payment of the invoice from the user 120 whose bicycle 110 has been maintained and/or repaired. The user 120 now pays e.g. by means of a mobile card reader 475. The mobile maintenance and repair unit 130 transmits a payment confirmation 480 to the maintenance and/or repair system 100, which registers the payment 485. The maintenance and/or repair system 100 preferably saves every order which has been carried out by a mobile maintenance and repair unit 130. Thus, it is possible to notice how many orders have been carried out by a mobile maintenance and repair unit 130 at any time.

The mentioned method for a maintenance and/or repair of a bicycle 110 forces by simple technical measures a commercial and correct maintenance and/or repair. In common bicycle repair shops, repair protocols and delivery notes are often not created and signed by a user, for example.

The mentioned method makes storage facilities for a huge number of bicycles 110 redundant by the local maintenance and/or repair of a bicycle 110 which leads to a massive cost reduction of a bicycle repair shop. Additionally, no theft protection is needed for the stored bicycles no, to be maintained and/or repaired because a maintenance and/or repair is always done directly at the location of the user 120. This is also an advantage over a common bicycle repair shop.

1. A method for maintaining and/or repairing at least one bicycle (110) of a plurality of bicycles (110) distributed in the field comprising first identification data, wherein the method comprises the following steps:
a. Receiving (140) a maintenance and/or repair request via a network, wherein the request comprises first identification data of the bicycle (110);
b. Sending (150) a maintenance and/or repair request to a mobile maintenance and repair unit (130) with a specification of a location where the bicycle (110) is available for maintenance and/or repair;
c. Receiving a confirmation that the mobile maintenance and repair unit (130) has arrived at the location.

2. The method according to claim 1, wherein sending the maintenance and/or repair order in step b. does not enable an identification of the bicycle (110).

3. The method according to claim 1 or 2, wherein receiving the confirmation comprises receiving second identification data of the bicycle (110).

4. The method according to claim 3, wherein the second identification data (210; 220) have been created by a reader by means of machine-reading an identification element on the bicycle.

5. The method according to claim 3 or 4, wherein the method further comprises the step of providing a list of parts of the identified bicycle (110) in reply to receiving the second identification.

6. The method according to one of the preceding claims, wherein the method further comprises the step of receiving a message, the message including at least one bicycle part used during the maintenance and/or repair.

7. The method according to claim 6, wherein the message comprises a part identification number of at least one bicycle part used during maintenance and/or repair.

8. The method according to claim 7, wherein the method further comprises the step of selecting a bicycle part for the at least one bicycle part used for maintenance and/or repair, included in the message.

9. The method according to one of the preceding claims, wherein step b comprises selecting a mobile maintenance and repair unit (130) of a plurality of mobile maintenance and repair units (130) by means of at least one predetermined criterion.

10. The method according to claim 9, wherein the at least one criterion comprises one or more of the following criteria:
i. Locations of the plurality of mobile maintenance and/or repair units (130);
ii. Inventories of the available parts in the plurality of mobile maintenance and repair units (130);
iii. A time specification included in the maintenance and/or repair request when the maintenance and/or repair is to be carried out.

11. The method according to claim 10, wherein criterion ii further considers a type and/or the bicycle (110) identified by means of the first identification.

12. The method according to claim 10 or 11, wherein criterion ii comprises the highest priority when selecting the mobile maintenance and repair unit (130), followed by criterion iii, followed by criterion i.

13. The method according to one of the preceding claims, further comprising the step of receiving (160) a confirmation of the maintenance and/or repair order from the mobile maintenance and repair unit.

14. The method according to one of the preceding claims, wherein the steps of receiving and sending (150; 160) comprise the usage of a mobile radio network and/or the Internet.

15. Maintenance and/or repair system (100) for at least on bicycle (110) of a plurality of bicycles (110) distributed in the field having first identification data, wherein the maintenance and/or repair system (100) comprises the following means:
a. Receiving means, configured for receiving (140) of a maintenance and/or repair request over a network, wherein the request comprises the first identification data of the bicycle (110);
b. Sending means, configured for sending (150) a maintenance and/or repair request to a mobile maintenance and repair unit (130) including a location where the bicycle (110) is located for maintenance and/or repair.
c. Receiving means, configured for receiving a confirmation that the mobile maintenance and repair unit (130) has arrived at the location.

16. Maintenance and/or repair system (100) according to claim 15, wherein the maintenance and/or repair system (100) is further configured to perform a method according to any of the claims 1-14.

17. Method for operating a mobile maintenance and repair unit (130) for at least one bicycle (110) of plurality of bicycles (110) distributed in the field, wherein the method comprises the following steps:
a. Receiving (150) a maintenance and/or repair request from a maintenance and/or repair system (100) according to claim 15 or 16;
b. Machine-reading of an identification element (200) at a bicycle (110) by means of a reader for receiving second identification data of the bicycle (110); and
c. Sending the second identification data of the bicycle (110) to the maintenance and/or repair system (100) according to claim 15 or 16.

18. The method according to claim 17, wherein the received maintenance and/or repair request (100) of step a does not allow an identification of the bicycle (110).

19. The method according to claim 17 or 18, wherein the method further comprises the step of receiving a list of parts of the identified bicycle (110) in reply to sending or machine-reading of the second identification.

20. The method according to claim 19, wherein the list of parts comprises a part identification number.

21. The method according to one of the claims 17-20, wherein the method further comprises the step of sending a message, the message including at least one bicycle part used during the maintenance and/or repair.

22. The method according to claim 21, wherein the message comprises a part identification number of at least one bicycle part used during maintenance and/or repair.

23. The method according to one of the claims 17-22, further comprising the step of sending (160) a confirmation of the maintenance and/or repair order to the maintenance and/or repair system (100).

24. The method according to one of the claims 17-23, wherein the steps of receiving and sending (150; 160) comprise the usage of a mobile radio network.

25. The method according to one of the claims 17-24, wherein at least one bicycle part, used by the mobile maintenance and repair unit (130), is identified by means of machine-reading the identification data.

26. The method according to claim 25 in conjunction with claim 20, wherein the read part identification number is compared to part identification numbers in the list of parts.

27. The method according to claim 26, issuing a message if it is determined that the machine-read part identification number does not match any part identification number stored in the list of parts.

28. A mobile maintenance and repair system (130) for maintaining and/or repairing of at least one bicycle (110) of a plurality of bicycles (110) distributed in the field, comprising the following means:
a. Receiving means, configured for receiving (150) a maintenance and/or repair request from a maintenance and/or repair system (100) according to claim 15 or 16;
b. Reader, configured for reading an identification element (200) at the bicycle (110) for receiving second identification data of the bicycle (110); and
c. Sending means, configured for sending the second identification data of the bicycle (110) to the maintenance and/or repair system (100) according to claim 15 or 16.

29. A mobile maintenance and repair unit (130) according to claim 28, wherein the mobile maintenance and repair unit (130) is further configured to perform a method according to one of the claims 17-27.

30. A bicycle (110) for being used in connection with a maintenance and/or repair system (100) according to one of the claim 15 and/or 16, comprising second identification data, machine-readable by a reader.

31. Bicycle (110) according to claim 30, wherein the second identification data are provided at or in the bicycle in form of one or more of the present codes (210; 220):
i. a code in an RFID chip;
ii. a bar code (220);
iii. A QR-code.

32. Bicycle (110) according to claim 30 or 31, further comprising first identification data, arranged at the bicycle (110), being readable without a reader.

33. A computer program comprising instructions for performing the methods according to claims 1-14 or according to 17-27.

34. A distributed bicycle maintenance system, comprising a maintenance and/or repair system (100) according to claims 15-16 and at least one mobile repair and maintenance unit (130) according to claims 28-29 for repairing at least one bicycle (110) according to claims 30-32.
